(19) United States
(12) Patent Application Publication
(10) Pub. No.: US 2025/0068696 A1
(43) Pub. Date: Feb. 27, 2025

(54) ONLINE SYSTEM AND METHOD FOR SOLVING CONTEXT-ATTENTIVE COMBINATORIAL BANDIT WITH OBSERVATIONS

(71) Applicant: International Business Machines Corporation, Armonk, NY (US)

(72) Inventor: Djallel BOUNEFFOUF, Poughkeepsie, NY (US)

(21) Appl. No.: 18/454,106

(22) Filed: Aug. 23, 2023

(51) Int. Cl. G06F 17/18; G06F 17/16

(52) U.S. Cl. CPC G06F 17/18; G06F 17/16

(57) ABSTRACT

A method for solving a Context-Attentive Combinatorial Bandit with Observations (CACBO) problem using a Context-Attentive Combinatorial Thompson Sampling with Observations (CACTSO) algorithm is provided where the method includes identifying a Context-Attentive Combinatorial Bandit with Observations problem having multiple arms, identifying a plurality of parameters including a total number of features N, a number of initially observed features V, an initially observed features set C^{V}, a number of observed additional features U, a distribution parameter, and a function λ(t) which is computed differently for stationary and nonstationary cases, initializing the initially observed features, the initially observed features set and the observed additional features, identifying a plurality of subsets C^{V}(t) for each time t from a plurality of predetermined times t, sampling a vector parameter for each context feature for a plurality of context features, identifying a best subset of features and selecting an arm based on the best subset of features.

### BACKGROUND

The present invention generally relates to a contextual bandit solution approach, and more specifically, to a contextual solution approach having a Context-Attentive Combinatorial Thompson Sampling with Observations approach.

The contextual combinatorial bandit problem is a variant of the extensively studied multi-armed combinatorial bandit problem, where at each iteration, the agent observes an N-dimensional context (i.e., feature vector) and uses that context, along with the rewards of the arms played in the past, to decide which arm to play to maximize the reward. The objective of the agent is to learn the relationship between the context and reward, in order to find the best arm-selection policy for maximizing the cumulative reward over time. The basic formulation of a stochastic Contextual bandit (MAB) problem can be simply stated as 1) there are K arms, where each arm has a fixed, unknown and independent probability-law of reward; 2) at each step, a player chooses an arm and receives a reward; and 3) the reward is drawn according to the selected arm's law and it is independent of previous actions. The more information that is known about a situation, the better chance there is to optimize the solution and to identify the best possible reward.

However, in real world problems only subsets of information about a situation are typically known. Unfortunately, for situations where observation of the full context vector at each iteration is not possible, current contextual combinatorial bandit approaches are not robust enough to produce an optimized solution to the problem.

### SUMMARY

A method for solving a Context-Attentive Combinatorial Bandit with Observations (CACBO) problem using a Context-Attentive Combinatorial Thompson Sampling with Observations (CACTSO) algorithm is provided where the method includes identifying a Context-Attentive Combinatorial Bandit with Observations problem having multiple arms, identifying a plurality of parameters including a total number of features N, a number of initially observed features V, an initially observed features set C^{V}, a number of observed additional features U, a distribution parameter, and a function λ(t) which is computed differently for stationary and nonstationary cases, initializing the initially observed features, the initially observed features set and the observed additional features, identifying a plurality of subsets C^{V}(t) for each time t from a plurality of predetermined times t, sampling a vector parameter for each context feature for a plurality of context features, identifying a best subset of features and selecting an arm based on the best subset of features

Embodiments of the invention are also directed to computer-implemented methods and computer program products having substantially the same features and functionality as the computer system described above.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows a block diagram of an example computer system for use in accordance with one or more embodiments of the present invention; and

FIG. 2 is an operational block diagram illustrating a method for solving a Context-Attentive Combinatorial Bandit with Observations (CACBO) problem using a Context-Attentive Combinatorial Thompson Sampling with Observations (CACTSO) algorithm, in accordance with one or more embodiments of the present invention.

### DETAILED DESCRIPTION

As discussed briefly above, the current contextual bandit approach is not robust enough to produce optimized solutions to problems that are constantly evolving where observation of the full context vector at each iteration is not possible. Consider the situation where for any given arm selection, observing the full context vector at each iteration of an arm-selection is impossible, but a small subset of V context variables are revealed during each selection before the agent chooses an additional subset of U features to observe. These parameters V and U, as well as a set of V′ immediately observed features, are fixed for all iterations. In other words, given only a partially observable context, the agent must learn to select both the best additional feature subset and the best arm to play, given the resulting U+V+V′ observed features.

This type of problem can be thought of as a Context-Attentive Combinatorial Bandit with Observations (CACBO) problem which occurs in real life situations. As one example, consider a clinical setting where a doctor may first take a look at patient's medical record (i.e., a partially observed context) to decide which medical test (i.e., additional context variables) to perform before choosing a treatment plan (i.e., selecting an arm to play). Unfortunately, it is often too costly or even impossible to conduct all possible tests (i.e., observe the full context) so the doctor must decide which subset of tests will result in the maximally effective treatment choice (i.e., maximize the reward). As another example, similar problems can arise in multi-skill orchestration for Artificial Intelligence (AI) agents. Consider a problem involving dialog orchestration, where a user's query is first directed to a number of domain-specific agents, each one providing a different response from which the user selects the best response. In this case, the orchestration agent must choose the best subset of experts to use. Thus, the query is the immediately observed part of the overall context, while the responses of domain-specific experts are the initially unobserved features from which a limited subset must be selected and observed, before choosing an arm (i.e. deciding on the best outcome from the available responses). For multi-purpose dialog systems, such as personal home assistants, retrieving features or responses from every domain specific agent has potential to cause a poor user experience because it is practically impossible and time expensive.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk. mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as for solving a contextual bandit problem having a trending reward function 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

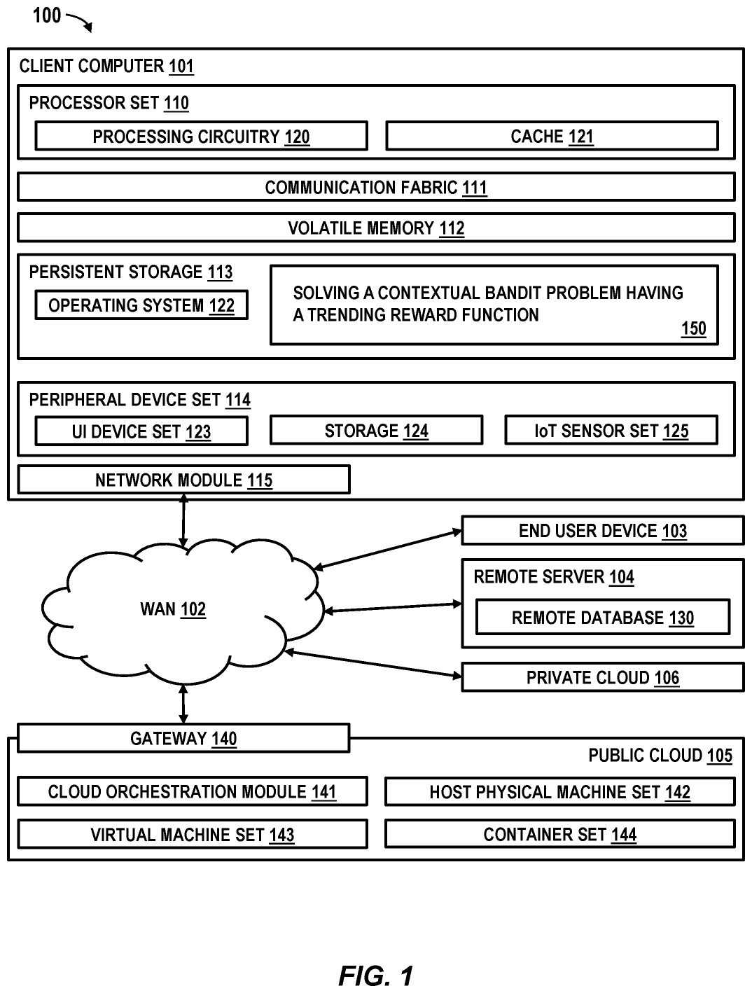

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

In accordance with an embodiment, consider the problem outlined below where it is assumed that at each time point t the environment generates a feature vector c(t)∈ [symbol] which the agent cannot observe fully. Unlike the situation in a Contextual Combinatorial Bandit with Restricted Context (CBRC) setting, the proposed setting provides a partial observation of the context, i.e. reveals the values c^{V} which is a subset of observed features C^{V}⊂C, V<N. Based on this partially observed context, the agent is allowed to request U additional unobserved features. The goal of the agent is to maximize its total reward over time via (1) the optimal choice of the additional set of features C^{U}, given the initial observed features c^{V}(t), and (2) the optimal choice of an action k∈A which is based on c^{V+U}(t)∈C^{U+V}. The algorithm for this problem setting is shown immediately below in Chart 1:

CHART 1
Algorithm 1 CACBO Problem Setting

| | |
|---|---|
| 1. | for t = 1 to T do |
| 2: | Context c(t) is drawn from distribution P_{c}(c) |
| 3: | The values c^{V}(t) of a subset C^{V} ⊂ C are observed |
| 4: | The agent selects a subset C^{U}(t) ⊆ C \ (C^{V}) |
| 5: | The values c^{U}(t) are revealed; |
| 6: | The agent chooses an arm k(t) |
| 7: | The reward r_{k/(t)} is revealed |
| 8: | The agent updates the policy π ∈ Π |
| 9: | t = i + 1 |
| 10: | end for |

This problem is defined as follows, where at each time point (iteration) t∈{1, . . . , T}, an agent is presented with a context (feature vector) e(t)∈ [symbol] before choosing an arm k∈A={1, . . . , K}. It is denoted by C={C1, . . . , C_{N}} the set of features (variables) defining the context. Let r(t)=(r₁(t), . . . , r_{K}(t)) denote a reward vector, where rₖ(t) is the reward at time t associated with the arm k∈A. Let π: [symbol] →A denote a policy, mapping a context c(t)∈ [symbol] into an action k∈A. Some probability distribution P_{c}(c) over the contexts in C, and a distribution of the reward, given the context and the action taken in that context is assumed. It is also assumed that the expected reward (with respect to the distribution Pᵣ(r|c,k)) is a linear function of the context.

Regarding the linear contextual combinatorial bandit, an assumption (Assumption 1.1) is made that the reward is a linear function of the context: rₖ(t)|c(t)=c(t)^{τ}μₖ+ϵ_{N}, where ϵ_{N} is a zero-mean random vector of size N, μₖ∈ [symbol] is given by the pdf of Gaussian distribution [symbol] (c(t)^{τ}μₖ,σ²), σ>0, and c(t)∈ [symbol] is a feature vector with ∥c(t)∥≤1, where ∥⋅∥ denotes the l₂-norm. Here the feature subset selection approach is built upon the Contextual Combinatorial combinatorial bandit (CCB) problem which is specified as follows. Each additional feature i∈C^{U} is associated with the corresponding random variable rᵢ(t)∈ [symbol] which indicates the reward obtained when choosing the i-th feature at time t. The reward associated with the set of selected features C^{U}(t) is r_{U}|c^{V}6∈ [symbol] , which is the reward of the selected action k(t) knowing the context vector c^{U+V}(t): r_{U}(t)|c^{V}(t)=rₖ₍ₜ₎|c^{U+V}(t). It is assumed that r_{U}|c^{V}(t)=f(rᵢ(t)), i∈C^{U}(t), for some function f(⋅). The contextual combinatorial combinatorial bandit setting can be viewed as a game, where the agent sequentially observes a context c^{V}(t), selects subsets C^{U}(t)⊂C and observes the rewards corresponding to the selected subsets. The reward function f(⋅) used to compute r_{U}(t) is defined as a sum of the outcomes of the features in C^{U}(t), i.e. r_{U}(t)=Σ_{i∈C}_{^{U}}₍ₜ₎rᵢ(t), although nonlinear rewards can also be used. The objective of the CCB algorithm is to maximize the reward over time. A stochastic model is considered here, where the expectation of rᵢ(t) observed for a feature i is a linear function of the context vector c_{V}(t): rᵢ(t)|c^{V}(t)=c^{V}(t)^{τ}θᵢ+ϵ_{V}, where θi is an unknown weight vector of size V (to be learned from the data) associated with the feature i and where ϵ_{V} is a zero-mean random vector of size V.

Regarding the linear contextual combinatorial combinatorial bandit, another assumption (Assumption 1.2) is made that the reward of selecting the set of features of size UC^{U}(t)⊂C\{C^{V}} is r_{U}(t)|c^{V}(t)=rₕ₍ₜ₎|c^{U+V}(t)=Σ_{i∈C}_{^{U}}₍ₜ₎c^{V}(t)^{τ}θᵢ+ϵ_{V}, where ϵ_{V} is a zero-mean random vector of size V, θᵢ∈ [symbol] is given by the pdf of Gaussian distribution [symbol] (c^{V}(t)^{τ}θᵢ, α²), α>0, and c^{V}(t)∈ [symbol] is a feature vector with ∥c^{V}(t)∥≤1, where ∥⋅∥ denotes the l₂-norm. The objective is to find an optimal policy π*∈Π, over T iterations or time points, so that the total reward is maximized. Assuming a stochastic setting where both contexts and rewards are random variables drawn from the probability distribution P_{c}(c) and Pᵣ(c, k), respectively, the novel problem setting can be formally defined as follows.

Definition 1 (Cumulative Regret): The cumulative regret over T iterations of an algorithm solving the CACBO problem, i.e. optimizing its policy π∈Π, is defined as

$$R ( T ) = max \text{?} {\sum }_{t = 1}^{T} 𝔼 [ r \text{?} ] - {\sum }_{t = 1}^{T} 𝔼 [ r \text{?} ] .$$

$$\text{?} \text{indicates text missing or illegible when filed}$$

The objective of a contextual combinatorial bandit algorithm is to minimize the cumulative regret R(T).

Definition 2 (Optimal Policy for CACBO): The optimal policy for solving the CACBO is to select the arm at time t: k*(t)=arg maxₖ μₖ^{T}c^{U*+V}(t), where c^{U*+V}(t) denotes the observation of the optimal feature set at time t. At this point, a lower bound on the expected regret of any algorithm used to solve this problem is derived as follows: Theorem 1: For any policy π∈Π computed by a particular algorithm for solving CACBO problem, give the initial feature subset C^{V} with

$$V < N \text{?} {N}^{2} \leq T$$

$$and$$

$$T \geq ( \begin{matrix}N - V \\ V\end{matrix} ) ,$$

$$\text{?} \text{indicates text missing or illegible when filed}$$

there exists probability distribution P_{c}(c) and Pᵣ(c, k), such that the lower bound of the expected regret accumulated by the algorithm over T iterations is:

$$Ω ( \sqrt{( U + V ) T} + \frac{( N - U )}{Δ} log ( T ) ) ,$$

with Δ=n_{k∈A}_{₁}_{C}_{^{U}}_{⊂O}E(rₖ|c^{U*+V})−E(rₖ|c^{U+V}); Note that this lower bound is worse than the classical contextual combinatorial bandit since the algorithm needs to explore both the features space and the arms space. Proof of this is given by:

$$R ( T ) = {\sum }_{t = 1}^{T} [ μ {\text{?}}^{⊤} \text{?} \text{?} \text{?} - μ {\text{?}}^{⊤} {\text{?}}^{U + V} \text{?} ] = \sum \text{?} [ \text{?} ] + \sum \text{?} [ \text{?} ] .$$

$$\text{?} \text{indicates text missing or illegible when filed}$$

It should be appreciated that

$$\sum \text{?} [ \text{?} ]$$

$$\text{?} \text{indicates text missing or illegible when filed}$$

is lower bounded by Ω({square root over ((U÷V)T))} based on the linear combinatorial bandit lower bound. Additionally, for

$$\sum [ \text{?} ]$$

$$\text{?} \text{indicates text missing or illegible when filed}$$

the expected regret of the combinatorial combinatorial bandit is

$$\sum \text{?} \sum \text{?} ,$$

$$\text{?} \text{indicates text missing or illegible when filed}$$

which is lower bounded by Ω((N−U)/Δ log(T)). By combining the two terms, the lower bound with the condition on N and T are determined.

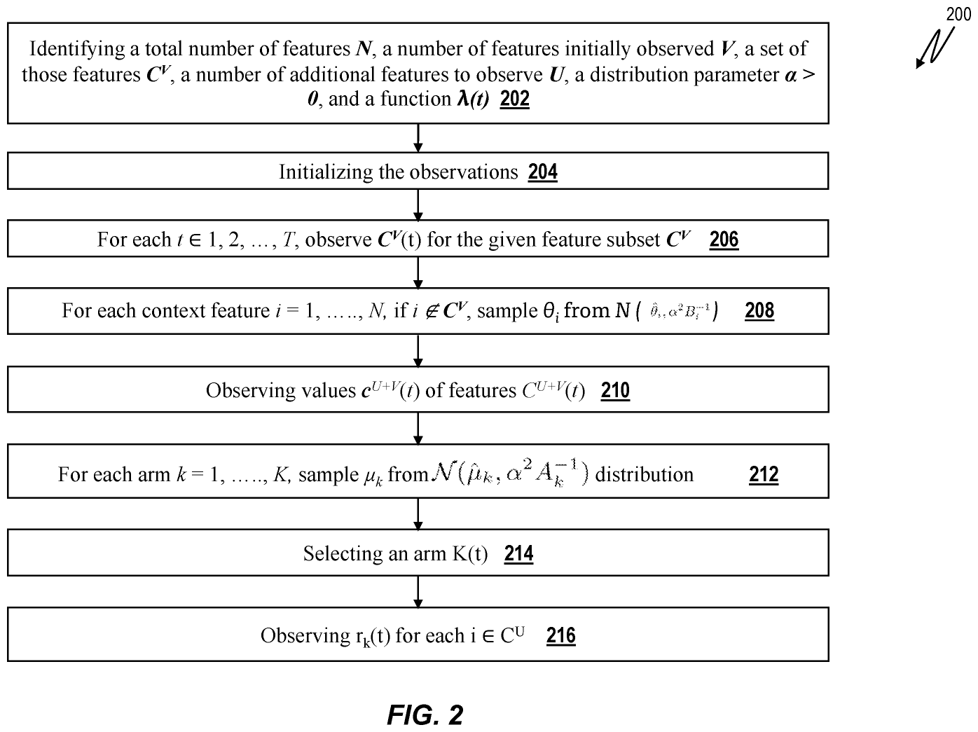

In accordance with an embodiment, referring to FIG. 2, a second algorithm (Algorithm 2) describing a Context-Attentive Combinatorial Thompson Sampling with Observations (CACTSO) method 100 for solving a CACBO problem is provided as shown immediately below in Chart 2.

```
Chart 2
Algorithm 2 Context-Attentive Thompson Sampling with
Observations (CACTSO)
  1: Requires Total number of features N; the number of features
    initially observed V; the wet of those features C^{V}; the number
    of additional features to observe U; the distribution parameter
    α > 0, and the function λ(t) computed differently for stationary
    and nonstationary cases.
  2: Initialize ∀k ∈ {1, ... , K}, Aₖ = I_{N}, gₖ = 0_{N}, \hat{μ}ₖ = 0_{N},
    and ∀i ∈ {1, ... , N}, Bᵢ = I_{N}, zᵢ = 0_{N}, \hat{θ}ᵢ = 0_{N},
  3: Foreach t ∈ 1, 2, ... , T do
  4:  observe c^{V}, given feature subset C^{V}
  5:  Foreach context feature i = 1, ... , N do
  6:  if i ∉ C^{V} then Sample θᵢ from [symbol] (\hat{θ}ᵢ, α²Bᵢ⁻¹)
    if
  7:  End do
  $8 : \qquad Select C \text{?} ( l ) = {arg max}_{\text{?}} {\sum }_{i ∈ {C}^{′}} c \text{?} {( \text{?} )}^{⊤} {θ}_{i}$
  9:  C^{U+V} (t) = C^{V} ∪ C^{U}(t)
10:  observe values c^{U+V}(t) of features in C^{U+V}(t)
11:  Foreach arm k = 1, ... , K do Sample μₖ form [symbol]
  (\hat{μ}ₖ, α²Aₖ⁻¹) distribution End do
$\begin{matrix}12 : & Select arm k ( t ) =\end{matrix} {arg max}_{\text{?}} c \text{?} {( \text{?} )}^{⊤} {μ}_{k}$
13:  Observe rₖ(t)
14:  Aₖ = Aₖ + c^{U+V}(t)c^{U+V}(t) [symbol] , gₖ = gₖ +
    c^{U+V}(t)rₖ(t), \hat{μ}ₖ = Aₖ⁻¹gₖ
15:  Foreach i ∈ C^{U}
16:  Bᵢ = λ(t)Bᵢ + c^{V}(t)c^{V}(t) [symbol] , zᵢ = zᵢ + c^{V}(t)rₖ(t),
    \hat{θ}ᵢ = λ(t)Bᵢ⁻¹zᵢ
17:  End do
18: End do [symbol]
indicates data missing or illegible when filed
```

In an embodiment, the method 200 includes identifying a total number of features N, a number of features initially observed V, a set of those features C^{V}, a number of additional features to observe U, a distribution parameter α>0, and a function λ(t) which is determined differently for stationary and nonstationary cases, as shown in operational block 202. The observations are then initialized as follows:

$$∀ k ∈ \{ 1 , … , K \} ,$$

$${A}_{k} = {I}_{N} ,$$

$${g}_{k} = {0}_{N} ,$$

$$\hat{{μ}_{k}} = {0}_{N} ,$$

$$and$$

$$∀ i ∈ \{ 1 , … , N \} ,$$

$${B}_{i} = {I}_{N} ,$$

$${𝓏}_{i} = {0}_{N} ,$$

$$\hat{{θ}_{i}} = {0}_{N} ,$$

as shown in operational block 204. For each t∈1, 2, . . . , T, observe C^{V}(t) for the given feature subset C^{V}, as shown in operational block 206. Then for each context feature i=1, . . . , N, if i∉C^{V} sample θᵢ from N(\hat{θ}ₖα²Bᵢ⁻¹), as shown in operational block 208. The method next includes selecting,

$${C}^{V} ( t ) = {arg max}_{{C}^{′} ⊆ {C}_{j} {C}^{V} , \vert {C}^{′} \vert = V} {\sum }_{i ∈ {C}^{′}} {{c}^{V} ( t )}^{⊤} {θ}_{i} , {C}^{U + V} ( t ) = {C}^{V} ⋃ {C}^{U} ( t ) ,$$

and observing values c^{U+V}(t) of features C^{U+V}(t), as shown in operational block 210, and for each arm k=1, . . . , K, sample μₖ from the N(\hat{μ}ₖ, α₂Aₖ⁻¹) distribution, as shown in operational block 212. The method further includes selecting an arm k(t) as follows:

$$k ( t ) = {arg max}_{k ⊂ \{ 1 , … , K \}} {{c}^{U + V} ( t )}^{⊤} {μ}_{k} ,$$

as shown in operational block 214 and observing rₖ(t), where,

$${A}_{k} = {A}_{k} + {c}^{U + V} ( t ) {{e}^{U + V} ( t )}^{⊤} , {g}_{k} = {g}_{k} + {c}^{U + V} ( t ) {r}_{k} ( t ) , {\dot{μ}}_{k} = {A}_{k}^{- 1} {g}_{k} ,$$

and for each i∈C^{U}

$${B}_{i} = λ ( t ) {B}_{i} + {c}^{V} ( t ) {{c}^{V} ( t )}^{⊤} , {z}_{i} = {z}_{i} + {c}^{V} ( t ) {r}_{k} ( t ) , {\hat{θ}}_{i} = λ ( t ) {B}_{i}^{- 1} {z}_{i} ,$$

as shown in operational block 216.

It should be appreciated that the method takes the total number of features N, the number of features initially observed V, the number of additional features to observe U, as its inputs, and the distribution parameter α>0 used in Contextual Thompson Sampling (CTS). The feature vectors c, and the parameter θᵢ and μₖ may be considered in dimension N, c^{V} meaning that all coordinates not in C^{V} are zero. Iteration over T steps is performed, where at each iteration t first observing values c^{V}(t) of features in the original observed subset C^{V} are observed. At each iteration t, a sample of the vector parameter θᵢ from the corresponding multivariate Gaussian distribution is taken separately for each feature i not yet observed thus far, to estimate \hat{θ}ᵢ. At each stage the best subset of features, C^{U}⊆C/C^{V} is selected, such that C^{U}(t)=arg max_{C′⊆C/C}_{^{V}}_{,|C}_{^{V}}_{|=0}Σ_{i∈C′}c^{V}(t)^{τ}θᵢ.

Once a subset of features is selected using the contextual combinatorial combinatorial bandit approach, the contextual combinatorial bandit setting is used to choose an arm based on the context consisting now of a subset of features. It is assumed that the expected reward is a linear function of a restricted context, E[rₖ(t)|c(t)]=c(t)^{T}μₖ; note that this assumption is different from the linear reward assumption of where a single parameter μ was considered for all arms, there was no restricted context, and for each arm, a separate context vector cₖ(t) was assumed. It is further assumed that reward rₖ(t) for choosing arm k at time t follows a parametric likelihood function P(r(t)|μₖ), and that the posterior distribution at time t+1, P(μ|r(t))∝P(r(t)|μ)P(μ) is given by a multivariate Gaussian distribution [symbol] (μₖ(t+1), α²Aₖ(t+1)⁻¹). At each time point, and for each arm, k-dimensional μₖ from [symbol] (μₖ(t), α²Aₖ(t)⁻¹) is sampled, an arm is chosen maximizing c(t)^{τ}μₖ, the reward rₖ(t) for choosing an arm k is obtained, and the relevant parameters are updated.

At this point, an upper bound on the regret of the policy computed by the CACTSO algorithm presented above is derived. However, to make the analysis more convenient, it is assumed that the algorithm has to choose between independent subset of features C^{V}. This makes the algorithm solving a contextual combinatorial bandit problem at the features level rather than a combinatorial contextual combinatorial bandit problem.

An assumption (Assumption 2: Heteroscedastic noise) regarding heteroscedastic noise is made where ∀C^{U+V}∈C with ρ(C^{U+V})>0 positive function, such that the noise uₖ=(t)−c^{U+V}(t)^{Y}μₖ is conditionally ρ(U+V)-subgaussian, that is for all t≥1 and ρ(U+V)∈R,

$$∀ λ ∈ R , E [ {e}^{λ {n}_{i}} ] \leq exp ( \frac{{λ}^{3} {ρ ( {C}^{U + V} )}^{2}}{2} ) .$$

It should be appreciated that this condition implies that the noise has zero mean and depends on CU+V where U is being chosen at each iteration. Thus, this heteroscedastic noise is due to the fact that the reward observed at the feature subset selection step depends on the performance of the arm selection step. The later step is creating time variance on the noise that the first algorithm is observing and vice versa.

Given the above, the following result may be derived using Theorem 2 which states that when the measurement noise nₜ satisfies assumption 2 herein above, with probability 1−δ, where 0<δ<1, ρ>0, with ∥cᵢ∥≤1, ∥μ∥≤1 and ∥θ∥≤1, the regret R(T) accumulated by the CACTSO in T iterations is upper-bounded by,

$$R ( T ) \leq ( ρ ( U + V ) \sqrt{T log ( K )} + V \sqrt{T ( N - V ) log ( N - V )} ) ( ln ( t ) + \sqrt{ln ( T ) ln ( \frac{1}{δ} )} ) , \\ where ρ = {max}_{{C}^{U + V} ⊂ C} ρ ( {C}^{U + V} ) .$$

Accordingly, this theorem states that the regret of the method depends on the following two components: the error caused by using the best features vector (upper-bounded by the regret of the CTS) and the error caused by choosing a suboptimal features subset (upper-bounded by the regret of the CTS in the contextual combinatorial bandit with heteroscedastic noise on rewards). Thus, there is still a gap between the lower bound of the problem and the upper bound of the method.

The lower bound of the problem and the upper bound of the method are both in two parts: the first part comes from the linear combinatorial bandit and the second part comes from the combinatorial combinatorial bandit. The first term of the lower bound as well as the first term of the upper bound scale in \sqrt{T}. However, the dependence on U+V is in \sqrt{U+V} for the lower bound, while it is in U+V for the upper bound. This comes from the fact that for the second term (combinatorial combinatorial bandits), the tightest lower bound which is problem dependent was used. To ease the comparison with the upper bound of the method (CACTSO), the problem independent lower bound in Ω(U\sqrt{N.T}) may be used. It appears that the method (CACTSO) essentially suffers from a log T penalty in comparison to the lower bound. This difference (which is not high) between the lower bound and the algorithm comes from the regret upper bound of CTS (see Lemma 2 below), which is used in the proof of Theorem 2.

Here Lemma 1 states that when the measurement noise nₜ satisfies Assumption 2, with probability 1−δ, where 0<δ<1, the upper bound on the regret R(T) for the CTS in the contextual combinatorial bandit problem with K arms and N features (context size) is given as

$$H ( T ) = O ( ρ N \sqrt{T log ( K )} ( ln ( T ) + \sqrt{ln ( T ) ln ( \frac{t}{δ} )} ) ) , \\ where ρ = {max}_{{C}^{U + V} ⊂ C} ρ ( {C}^{U + V} ) .$$

Proof of this can be determined using the noise being heteroscedastic, where the main difference is that

$${l}_{i} = R \sqrt{N ln ( \frac{{t}^{3}}{δ} ) + 1} , {v}_{t} = R \sqrt{9 N ln ( \frac{t}{δ} )} ,$$

where R>0 is replaced by

$${l}_{t} = {ρ}_{t} ( U + V ) \sqrt{N ln ( \frac{{t}^{3}}{δ} ) + 1} , {v}_{t} = {ρ}_{t} ( U + V ) \sqrt{9 N ln ( \frac{t}{δ} )} .$$

In that case the noise does not depend on time which is the case in this setting. Therefore, these two quantities needs to be upper bound by

$${l}_{i} \leq ρ \sqrt{N ln ( \frac{{t}^{2}}{δ} ) + 1} , {v}_{t} \leq ρ \sqrt{9 N ln ( \frac{t}{δ} )} .$$

Moreover, Lemma 2 states that with probability 1−δ, where 0<δ<1, the upper bound on the regret R(T) for the CTS in the contextual combinatorial bandit problem with K arms and N features (context size) may be given by

$$R ( T ) = O ( N \sqrt{T log ( K )} ( ln ( T ) + \sqrt{ln ( T ) ln ( \frac{1}{δ} )} ) ) .$$

Proof of Theorem 2 can be shown by using the definition for optimal policy and the method of the invention to express the regret at time t as

$$R ( T ) = {\sum }_{i = 1}^{T} [ {μ}_{{k}^{⋁} ( t )}^{⊤} {c}^{U \hat{} + T} ( t ) - {μ}_{k ( t )}^{⊤} {c}^{U \hat{} + V} ( t ) ] + {\sum }_{i = 1}^{T} [ {μ}_{k ( t )}^{⊤} {c}^{U \hat{} + V} ( t ) - {μ}_{k ( t )}^{⊤} {c}^{U + V} ( t ) ] .$$

Next, using Assumption 1.2 above gives

$$R ( T ) = {\sum }_{i = 1}^{T} [ {μ}_{k \hat{} ( t )}^{⊤} {c}^{U \hat{} + V} ( t ) - {μ}_{k ( t )}^{⊤} {c}^{U \hat{} + V} ( t ) ] + {\sum }_{i = 1}^{T} [ \sum \text{?} - \sum \text{?} ] = {R}_{1} ( T ) + {R}_{2} ( T ) ,$$

$$\text{?} \text{indicates text missing or illegible when filed}$$

where [symbol] is the optimal parameter for the feature i. For R1(T) and R2(T), respectively Lemma 1 and Lemma 2 may be used to obtain 1) first, for the contextual combinatorial bandit which chooses the action, U+V dimensions and K actions. There are U+V dimensions because the contextual variables which are not used are set to zero giving, R₁(T)≤ρ(U+V)\sqrt{T log(K)}(ln(T)÷\sqrt{ln(T)ln(1/ δ)}), 2) second, for the contextual combinatorial bandit, which chooses the contextual variable with V dimensions and

$$( \begin{matrix}N - V \\ U\end{matrix} )$$

actions, by using the fact that log

$$( \begin{matrix}N - V \\ U\end{matrix} ) \leq ( N - V ) log ( N - V ) ,$$

is it found that R₂(T)≤V\sqrt{T(N−V)log(N−V)}(ln(T)+{square root over ((ln(T)ln(1/ δ))}. Thus, the two cases are independent and the bounds can be combined to get an upper bound for the method of the invention (CACTSO Algorithm).

It should be appreciated that the method of the invention (CACTSO algorithm) was compared with the (1) Random-EI algorithm, (2) Random-fix algorithm, and (3) the method for context-attentive combinatorial bandits, Thompson Sampling with Restricted Context (TSRC). As is known, in addition to the V observed features, the Random-EI algorithm selects a Random subset of features of the specified size U at each Iteration (thus, Random-EI), and then invokes the contextual combinatorial bandit algorithm (CTS). The Random-fix algorithm invokes CTS on a subset of U+V features, where the subset V is randomly selected once prior to seeing any data samples, and remains fixed. The context-attentive combinatorial bandits proposed in TSRC solves the CBRC (Contextual Combinatorial Bandit with Restricted Context) problem discussed hereinabove, where at each iteration, the algorithm decides on U+V features to observe (referred to as unobserved context). In the setting of the method of the invention, however, V out of N features are immediately observed at each iteration (referred to as known context), then TSRC decision mechanism is used to select U additional unknown features to observe, followed by Contextual Thompson Sampling (CTS) on U+V features.

An empirical evaluation of the Random-fix algorithm, the Random-EI algorithm, the CACTSO and the TSRC was performed on several publicly available datasets, as well as on a proprietary corporate dialog orchestration dataset. To simulate the known and unknown context space, 10% of the context feature space of each dataset was fixed to be known at the onset and explore a subset of U unknown features. To consider the possibility of nonstationarity in the unknown context space over time, a weight decay parameter λ(t) was introduced that reduces the effect of past examples when updating the CACTSO parameters (See the stationary case as CACTSO and fix λ(t)=1). For the nonstationary setting, nonstationarity in the unknown feature space was simulated by duplicating each dataset, randomly fixing the known context in the same manner as above, and shuffling the unknown feature set-label pairs. Then events in the original dataset were stochastically replaced with their shuffled counterparts, with the probability of replacement increasing uniformly with each additional event (reference is made to the nonstationary case as NCACTSO and use λ(t) as defined by the GP-UCB algorithm). NCACTSO was compared to Weighted TSRC (WTSRC), the nonstationary version of TSRC. The WTSRC makes updates to its feature selection model based only on recent events, where recent events are defined by a time period, or “window” w. A value of 100 was chosen for w (w=100) for WTSRC and the total average reward over 200 trials across a range of U corresponding to various percentages of N for each algorithm is reported in Table 1 below.

TABLE 1
Total average reward, O = 10%

| | Warfarin | | | | Warfarin | | |
|---|---|---|---|---|---|---|---|
| U | 20% | 40% | 60% | U | 20% | 40% | 60% |
| TSRC | 53.28 ± 1.08 | 57.60 ± 1.16 | 59.87 ± 0.69 | WTSRC | 55.83 ± 0.55 | 58.00 ± 0.83 | 59.85 ± 0.60 |
| CACTSO | 53.65 ± 1.21 | 58.55 ± 0.67 | 60.40 ± 0.74 | NCACTSO | 59.47 ± 2.89 | 59.34 ± 2.04 | 63.26 ± 0.75 |
| Random-fix | 51.05 ± 1.31 | 53.55 ± 0.97 | 55.15 ± 0.83 | Random-fix | 43.91 ± 1.17 | 47.67 ± 1.08 | 54.18 ± 1.03 |
| Random-EI | 43.65 ± 1.21 | 48.55 ± 1.67 | 50.40 ± 1.33 | Random-EI | 47.78 ± 2.11 | 52.55 ± 1.83 | 55.45 ± 1.54 |
| | Covertype | | | | Covertype | | |
| U | 20% | 40% | 60% | U | 20% | 40% | 60% |
| TSRC | 54.64 ± 1.87 | 63.35 ± 1.87 | 69.59 ± 1.72 | WTSRC | 50.26 ± 1.58 | 58.99 ± 1.81 | 64.91 ± 1.38 |
| CACTSO | 65.57 ± 2.17 | 72.58 ± 2.36 | 78.58 ± 2.35 | NCACTSO | 48.50 ± 1.05 | 68.17 ± 3.14 | 83.78 ± 5.51 |
| Random-fix | 53.11 ± 1.45 | 59.67 ± 1.07 | 64.18 ± 1.03 | Random-fix | 43.11 ± 3.05 | 49.67 ± 2.77 | 53.18 ± 2.33 |
| Random-EI | 46.15 ± 2.61 | 52.55 ± 1.81 | 55.45 ± 1.5 | Random-EI | 44.45 ± 4.44 | 46.65 ± 3.88 | 53.45 ± 3.61 |
| | CNAE-9 | | | | CNAE-9 | | |
| U | 20% | 40% | 60% | U | 20% | 40% | 60% |
| TSRC | 33.57 ± 2.43 | 38.62 ± 1.68 | 42.05 ± 2.14 | WTSRC | 19.91 ± 2.67 | 30.86 ± 2.92 | 36.01 ± 2.88 |
| CACTSO | 29.84 ± 1.82 | 39.10 ± 1.41 | 40.52 ± 1.42 | NCACTSO | 30.88 ± 0.96 | 34.91 ± 1.93 | 42.04 ± 1.52 |
| Random-fix | 33.01 ± 1.82 | 37.67 ± 1.68 | 39.18 ± 1.52 | Random-fix | 13.01 ± 3.45 | 21.77 ± 3.08 | 24.18 ± 2.43 |
| Random-EI | 32.05 ± 2.01 | 36.65 ± 1.90 | 37.47 ± 1.75 | Random-EI | 16.15 ± 2.44 | 22.55 ± 2.18 | 25.45 ± 2.15 |

| | |
|---|---|
| (a) Stationary Setting | (b) Nonstationary Setting |

The results in table 1 are promising, with the method 100 of the invention (CACTSO) outperforming the state of the art in the majority of cases across both settings. The most notable exception is found for the CNAE-9 dataset, where CACTSO sometimes outperforms or nearly matches the TSRC performance. This outcome is expected, since in the original work on TSRC, the mean error rate of TSRC was only 0.03% lower than the error corresponding to randomly fixing a subset of unknown features to reveal for each event on CNAE-9. This observation suggests that, for this particular dataset, there may not be a subset of features which would be noticeably more predictive of the reward than the rest of the features. A deeper analysis of the Covertype dataset was performed, examining multi-staged selection of the U unknown context feature sets. In CACTSO, the known context is used to select all U additional context feature sets at once. In a multi-staged approach, the known context grows and is used to select each of the U additional context features incrementally. Maintaining λ(t)=1, for the stationary case two cases of the CACTSO algorithm as CACTSO and CACTSO-Staged respectively were denoted and their performance was reported when 10% of the context is randomly fixed, across various U. Note that when the remaining 90% of features are revealed, the CACTSO and TSRC methods all reduce to simple Contextual Thompson Sampling (CTS) with the full feature set.

Similarly, when 0 additional feature sets are revealed, the methods all reduce to CTS with a sparsely represented known context. Observe that CACTSO consistently outperforms CACTSO-Staged across all U tested. CACTSO-Staged likely suffers because incremental feature selection adds nonstationarity to the known context-CACTSO learns relationships between the known and unknown features while CACTSOStaged learns relationships between them as the known context grows. Nonetheless, both methods outperform TSRC. In the nonstationary case we use the GP-UCB algorithm for λ(t) with reference to the single and multi-staged cases, NCACTSO and NCACTSO-Staged, where it was observed that NCACTSO and NCACTSO-Staged have comparable performance, and the improvement gain over baseline, in this case WTSRC, is even greater than in the stationary case.

Next, the method of the invention was evaluated on Customer Assistant, a proprietary multi-skill dialog orchestration dataset. Recall that this kind of application motivates the CACBO setting because there is a natural divide between the known and unknown context spaces; the query and its associated features are known at the onset and the potential responses and their associated features are only known for the domain specific agents the query is posed to. The Customer Assistant orchestrates 9 domain specific agents which we arbitrarily denote as Skill₁, . . . , Skill₉ in the discussion that follows. In this application, example skills lie in the domains of payroll, compensation, travel, health benefits, and so on. In addition to a textual response to a user query, the skills orchestrated by Customer Assistant also return the following features: an intent, a short string descriptor that categorizes the perceived intent of the query, and a confidence, a real value between 0 and 1 indicating how confident a skill is that its response is relevant to the query, where skills have multiple intents associated with them. The orchestrator uses all the features associated with the query and the candidate responses from all of the skills to choose which skill should carry the conversation.

The Customer Assistant dataset contains 28,412 events associated with a correct skill response. Each query was encoded by averaging 50 dimensional GloVe word embeddings for each word in each query and for each skill a feature set was created consisting of its confidence and a one-hot encoding of its intent. The skill feature set size for Skill₁, . . . , Skill₉ are 181, 9, 4, 7, 6, 27, 110, 297, and 30 respectively. The query features and all of the skill features were concatenated to form a 721 dimensional context feature vector for each event in this dataset. Recall that there is no need for simulation of the known and unknown contexts; in a live setting the query features are immediately calculable or known, whereas the confidence and intent necessary to build a skill's feature set are unknown until a skill is executed. However, because the confidence and intent for a skill are both accessible post execution, they were revealed together. This was accommodated by slightly modifying the objective of CACTSO to reveal U unknown skill feature sets instead of U unknown individual features for each event. A deeper analysis of the Customer Assistant dataset was performed, examining multi-staged selection of the U unknown context feature sets. Maintaining λ(t)=1, for the stationary case, it can be shown both that CACTSO-Staged and CACTSO methods outperform TSRC by a large margin. For the nonstationary case, nonstationarity was simulated in the same manner as the publicly available datasets, except using the natural partition of the query features as the known context and the skill feature sets as the unknown context instead of simulated percentages. The GP-UCB algorithm for λ(t) was used to illustrate the performance of NCACTSO and NCACTSO-Staged alongside WTSRC and it was observed that NCACTSO slightly outperforms NCACTSO-Staged, and both outperform the WTSRC baseline.

Accordingly, the method 100 provides a unique and novel variant of the contextual combinatorial bandit problem with only partially observable context and the option of requesting a limited number of additional observations. The problem setting was motivated by several realistic scenarios, including medical applications as well as multi-domain dialog systems, where some of the context features are easier and cheaper to obtain, while the rest of the features are more expensive. Additionally, a unique and novel algorithm is provided and is designed to take advantage of the initial partial observations.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

What is claimed is:

1. A method for solving a Context-Attentive Combinatorial Bandit with Observations (CACBO) problem using a Context-Attentive Combinatorial Thompson Sampling with Observations (CACTSO) algorithm, the method comprising:
identifying the Context-Attentive Combinatorial Bandit with Observations problem having multiple arms;
identifying a plurality of parameters including a total number of features N, a number of initially observed features V, an initially observed features set C^{V}, a number of observed additional features U, a distribution parameter, and a function λ(t) which is computed differently for stationary and nonstationary cases;
initializing the initially observed features, the initially observed features set and the observed additional features;
identifying a plurality of subsets C^{V}(t) for each time t from a plurality of predetermined times t;
sampling a vector parameter for each context feature for a plurality of context features;
identifying a best subset of features; and
selecting an arm based on the best subset of features.

2. The method of claim 1, wherein identifying the CACBO problem includes an agent selecting the CACBO problem and a plurality of features, where each of the multiple arms includes an unknown and independent probability-law of reward.

3. The method of claim 1, wherein identifying a plurality of parameters includes an agent observing the total number of features N, the number of initially observed features V, and the number of observed additional features U.

4. The method of claim 1, wherein identifying a plurality of parameters includes determining the function λ(t) for stationary cases differently than determining the function λ(t) for nonstationary cases.

5. The method of claim 1, wherein initializing includes initializing the initially observed features, the initially observed features set and the observed additional features to a predetermined initial value.

6. The method of claim 1, wherein identifying a plurality of subsets C^{V}(t) includes performing an iteration of T steps and observing values C^{V}(t) for each iteration step T that are within the initially observed features set C^{V}.

7. The method of claim 1, wherein sampling the vector parameter includes, for each iteration step T, obtaining a sample of the vector parameter from a corresponding multivariate Gaussian distribution separately for each feature not yet observed to generate an estimated vector parameter.

8. The method of claim 1, wherein identifying the best subset of features includes selecting the best subset of features at each iteration step T.

9. The method of claim 1, wherein identifying the best subset of features includes using a contextual combinatorial combinatorial bandit approach.

10. The method of claim 1, wherein selecting the arm includes using a contextual combinatorial bandit approach based on a context that the best subset of features.

11. A computing system, comprising:
a machine learning system for implementing a method for solving a Context-Attentive Combinatorial Bandit with Observations (CACBO) problem using a Context-Attentive Combinatorial Thompson Sampling with Observations (CACTSO) algorithm, wherein the method includes:
identifying the Context-Attentive Combinatorial Bandit with Observations problem having multiple arms;
identifying a plurality of parameters including a total number of features N, a number of initially observed features V, an initially observed features set C^{V}, a number of observed additional features U, a distribution parameter, and a function λ(t) which is computed differently for stationary and nonstationary cases;
initializing the initially observed features, the initially observed features set and the observed additional features;
identifying a plurality of subsets C^{V}(t) for each time t from a plurality of predetermined times t;
sampling a vector parameter for each context feature for a plurality of context features;
identifying a best subset of features; and
selecting an arm based on the best subset of features.

12. The computing system of claim 11, wherein identifying the CACBO problem includes an agent selecting the CACBO problem and a plurality of features, where each of the multiple arms includes an unknown and independent probability-law of reward.

13. The computing system of claim 11, wherein identifying a plurality of parameters includes an agent observing the total number of features N, the number of initially observed features V, and the number of observed additional features U.

14. The computing system of claim 11, wherein identifying a plurality of parameters includes determining the function λ(t) for stationary cases differently than determining the function λ(t) for nonstationary cases.

15. The computing system of claim 11, wherein initializing includes initializing the initially observed features, the initially observed features set and the observed additional features to a predetermined initial value.

16. The computing system of claim 11, wherein identifying a plurality of subsets C^{V}(t) includes performing an iteration of T steps and observing values C^{V}(t) for each iteration step T that are within the initially observed features set C^{V}.

17. The computing system of claim 11, wherein sampling the vector parameter includes, for each iteration step T, obtaining a sample of the vector parameter from a corresponding multivariate Gaussian distribution separately for each feature not yet observed to generate an estimated vector parameter.

18. The computing system of claim 11, wherein identifying the best subset of features includes selecting the best subset of features at each iteration step T using a contextual combinatorial combinatorial bandit approach.

19. The computing system of claim 11, wherein selecting the arm includes using a contextual combinatorial bandit approach based on a context that the best subset of features.

20. A computer program product comprising a computer readable storage medium having program instructions embodied therewith, the program instructions executable by a processor to cause the processor to perform operations for implementing a method for solving a Context-Attentive Combinatorial Bandit with Observations (CACBO) problem using a Context-Attentive Combinatorial Thompson Sampling with Observations (CACTSO) algorithm, the method comprising:
identifying the Context-Attentive Combinatorial Bandit with Observations problem having multiple arms;
identifying a plurality of parameters including a total number of features N, a number of initially observed features V, an initially observed features set C^{V}, a number of observed additional features U, a distribution parameter, and a function λ(t) which is computed differently for stationary and nonstationary cases;
initializing the initially observed features, the initially observed features set and the observed additional features;
identifying a plurality of subsets C^{V}(t) for each time t from a plurality of predetermined times t;
sampling a vector parameter for each context feature for a plurality of context features;
identifying a best subset of features; and
selecting an arm based on the best subset of features.
